(19) United States
(12) Patent Application Publication
(10) Pub. No.: US 2008/0024440 A1
(43) Pub. Date: Jan. 31, 2008

(54) Device and Method for Providing Resistive and Vibrotactile Effects

(75) Inventors: Neil T. Olien, Montreal (CA); Alexander Jasso, San Jose, CA (US); George V. Anastas, San Carlos, CA (US); Erik Shahoian, San Ramon, CA (US); Raymond Yu, San Jose, CA (US)

Correspondence Address: PATENT DEPARTMENT (51851);KILPATRICK STOCKTON LLP, 1001 WEST FOURTH STREET, WINSTON-SALEM, NC, 27101, US

(73) Assignee: Immersion Corporation, San Jose, CA (US)

(21) Appl. No.: 11/869,588

(22) Filed: Oct. 9, 2007

Related U.S. Application Data
(62) Division of application No. 10/934,142, filed on Sep. 3, 2004.

(51) Int. Cl. G09G 5/00

(52) U.S. Cl. 345/156

(57) ABSTRACT

Systems and methods for providing resistive and vibrotactile feedback from a single actuator are described. One described system comprises a manipulandum, and a resistive haptic actuator configured to generate a resistive haptic force in order to generate a vibrotactile haptic effect.

### CROSS-REFERENCE TO RELATED APPLICATIONS

This application is a divisional application of co-pending U.S. patent application Ser. No. 10/934,142 entitled “Device and Methods for Providing Resistive and Vibrotactile Effects” filed Sep. 3, 2004, the entirety of which is hereby incorporated by reference.

### FIELD OF THE INVENTION

The present invention generally relates to devices and methods for providing haptic effects. This invention more particularly relates to a haptic actuator capable of providing resistive and vibrotactile feedback.

### BACKGROUND

A haptic actuator provides tactile sensations to a user of an interface device incorporating the actuator. The actuator may be active or resistive. An active actuator may provide feedback to the user through kinesthetic or vibrotactile effects. The active actuator moves an interface device, such as a manipulandum, or imparts a vibration in the device. In contrast, a resistive actuator requires that a user move an input device. The resistive actuator then provides haptic feedback by resisting the movement.

Conventional interface devices typically incorporate either an active or resistive actuator. An interface device will typically not incorporate both an active and passive actuator because of the complexity, size, and expense of incorporating two separate actuators.

Thus a need exists for a compact and efficient actuator capable of providing effective resistive and vibrotactile feedback.

### SUMMARY

An embodiment of the present invention provides resistive and vibrotactile effects. One embodiment of the present invention comprises a manipulandum and a resistive haptic actuator configured to generate a resistive haptic force in order to generate a vibrotactile haptic effect.

This embodiment is mentioned not to limit or define the invention, but to provide an example of embodiments of the invention to aid understanding thereof. Embodiments are discussed in the Detailed Description, and further description of the invention is provided there. Advantages offered by the various embodiments of the present invention may be further understood by examining this specification.

### BRIEF DESCRIPTION OF THE FIGURES

These and other features, aspects, and advantages of the present invention are better understood when the following Detailed Description is read with reference to the accompanying drawings, wherein:

FIG. 1 is an illustrative environment for implementation of one embodiment of the present invention;

FIG. 2 is a side view of a manipulandum and haptic actuator in one embodiment of the present invention;

FIG. 3 is a side view of a manipulandum and haptic actuator in another embodiment of the present invention;

FIG. 4 is a cross-section view of a manipulandum and haptic actuator in another embodiment of the present invention;

FIG. 5 is a cross-section view of a manipulandum and haptic actuator in another embodiment of the present invention;

FIG. 6 is a cross-section view of a manipulandum and haptic actuator in another embodiment of the present invention;

FIG. 7 is a cross-section view of a manipulandum and haptic actuator in another embodiment of the present invention;

FIG. 8 is a cross-section view of a manipulandum and haptic actuator in another embodiment of the present invention;

FIG. 9 is a cross-section view of a manipulandum and haptic actuator in another embodiment of the present invention;

FIG. 10 is a flowchart illustrating a method for providing resistive and vibrotactile feedback in one embodiment of the present invention; and

FIG. 11 is a flowchart illustrating a method for providing haptic feedback in one embodiment of the present invention.

### DETAILED DESCRIPTION

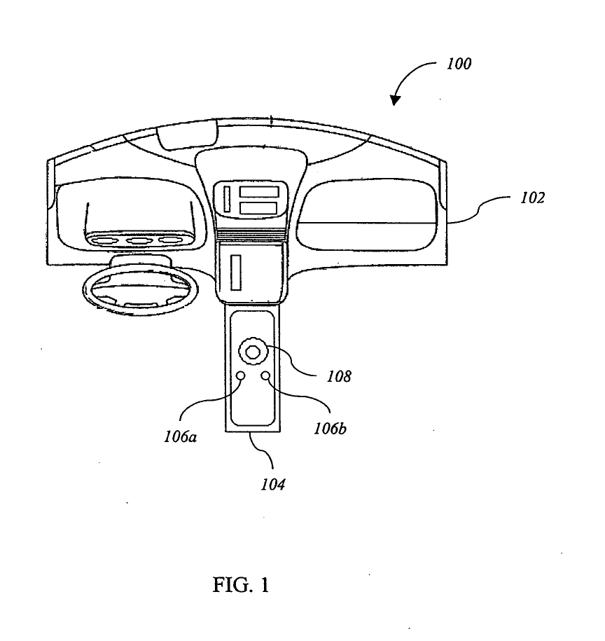

Embodiments of the present invention comprise devices and methods for providing resistive and vibrotactile effects. Referring now to the drawings in which like numerals indicate like elements throughout the several figures, FIG. 1 is an illustrative environment for implementation of one embodiment of the present invention. The environment shown is an automotive interior 100. The automotive interior 100 comprises a dashboard 102, which comprises instrumentation and controls and may comprise one or more displays. The interior 100 also comprises a center console 104. Mounted on the center console 104 are several manipulanda, interface elements that a driver or other occupants of the automotive interior 100 can manipulate. The manipulanda comprise a plurality of buttons 106a,b and a knob 108. In one embodiment, the user utilizes the buttons 106a,b to access specific applications, such as an address book. Once the user has accessed the address book application, the user utilizes the knob 108 to navigate through the various elements of the user interface, such as menus or a list of names contained in the address book application. The embodiment shown in FIG. 1 provides haptic feedback to the knob 108 to enhance the user's interaction with the knob 108. For example, the haptic feedback may comprise providing a detent effect between each of the address book entries. The haptic feedback may also comprise limiting the range of motion of the knob 108 when the end of a displayed list is reached.

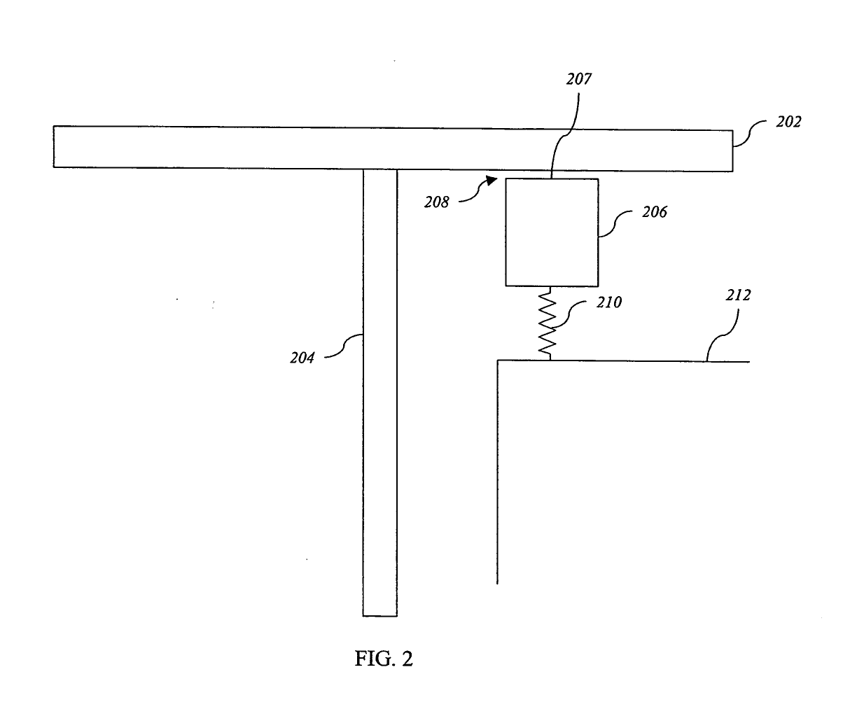

A device according to the present invention may provide haptic feedback in various manipulanda, such as the knob (108) shown in FIG. 1. FIG. 2 is a side view of a manipulandum and haptic actuator in one embodiment of the present invention. In the embodiment shown in FIG. 2, the manipulandum is a knob 202. The knob 202 may be, for example, the knob (108) shown in the automotive interior (100) of FIG. 1. An embodiment of the present invention may be used in various other implementations. For example, the manipulandum may be a scroll wheel in a personal digital assistant, a slider on a control panel, or a jog/shuttle video control in a handheld remote control for a video recorder or player.

The knob 202 is mounted on a shaft 204 to allow the knob 202 to rotate in a plane perpendicular to the shaft 204. The shaft 204 is shown mounted to the bottom of the knob 202 in FIG. 2. However, numerous other configurations are possible. For example, in one embodiment, the shaft 204 passes through the knob 202. In another embodiment, the knob 202 rotates within a channel and comprises only small projections on each side at the center of rotation to secure it within the channel. The shaft 204 of the knob 202 is mounted so that the knob 202 can rotate. For example, in one embodiment, the shaft 204 is mounted in a bearing that is attached to the housing in which the know 202 is installed.

On the side of the knob 202 shown in FIG. 2 on which the shaft 204 is mounted is a resistive haptic actuator 206. In the embodiment shown, the resistive haptic actuator is an electromagnetic brake 206. The electromagnetic brake 206 may be mounted in alternative locations as well, such as on the opposite side of the knob 202 from the shaft, on the shaft itself, or on an edge of the knob.

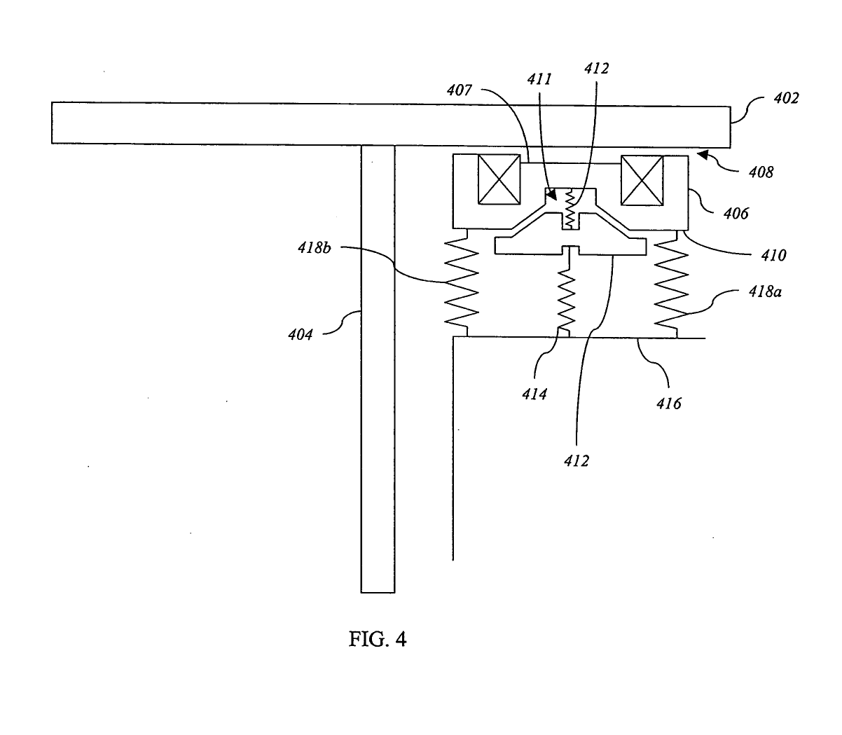

The electromagnetic brake 206 comprises a core (not shown) and a magnetic coil (not shown) wrapped around the core. These elements are shown in further detail in FIGS. 4-9, which are cross-section views of various actuators and manipulanda. When the core is energized, e.g., when a current is applied to the coil, the electromagnetic brake 206 exerts a force on the knob 202. For example, in the embodiment shown in FIG. 2, the electromagnetic brake 206 is drawn towards the knob 202. One side 207 of the brake 206 comes into contact with the knob 202, providing a resistance. The current provided to the coil can be controlled to provide various haptic effects. For example, a high current applied to the coil may produce a barrier effect on the knob 202, stopping the knob's 202 movement. The core may be, for example, a pot core, an E core, a magneto-strictive core, or some other suitable type of electromagnetic core. In the embodiment shown, the core is a pot core, with the top of the pot core closest to the manipulandum 202.

In the embodiment shown, the electromagnetic brake 206 performs multiple functions. The brake 206 exerts a resistive force on the knob 202 as described above. The brake 206 is also configured to provide a vibrotactile feedback to the knob 202. The dual actuation may be performed in various ways. For example, the full actuator may perform dual actuation, i.e., the entire actuator may vibrate and impart a vibration on the knob 202. Alternatively, the actuator may comprise multiple coils, which are energized independently within the actuator based on whether a resistive or vibrotactile effect is desired. In yet another embodiment, the actuator passes the magnetic flux created by both types of actuation through the same core.

The electromagnetic brake 206 provides vibrotactile feedback directly to the underside of the knob 202. In other embodiments, the actuator provides a resistive effect to the manipulandum and provides vibrotactile feedback through a ground, such as through the housing of the device housing the manipulandum. For example, the electromagnetic brake 206 may be configured to contact the housing, imparting a vibration on the housing in which the knob, or other elements of the interface, is installed.

The electromagnetic brake may be formed in various shapes. In the embodiment shown, the electromagnetic brake 206 is shaped like a cube, having six sides. The view shown in FIG. 2 is a cross section of the cube, i.e., only four sides are illustrated. The electromagnetic brake 206 is capable of providing resistive and vibrotactile feedback. To provide vibrotactile effects, the electromagnetic brake 206 is mounted so that a small gap 208 is present between a surface of the knob 202 and one side 207 of the brake 206. Alternatively, a small shim may be placed between a surface of the knob 202 and the braking surface of the brake. Other configurations may also be utilized. The small gap 208 or shim allows for movement of the electromagnetic brake. By varying the frequency and amplitude of the current applied to the coil of the electromagnetic brake 206, the frequency and amplitude of the movement of the brake 206 can be controlled so as to provide vibrotactile feedback to a user. For example, if a short duration, high amplitude current is applied to the electromagnetic brake 206, the electromagnetic brake produces a “pop” sensation on the knob. Other vibrotactile effects may also be implemented, such as a jolt, shake, buzz, or other suitable vibrotactile effect.

The embodiment shown also comprises a spring 210. A first end of the spring 210 is attached to the side of the electromagnetic brake 206 opposite the braking surface. The other end of the spring 210 is attached to a ground 212. When the electromagnetic brake 206 vibrates, it induces a vibration in the spring 210. The spring 210 continues to vibrate after power to the electromagnetic brake 206 ceases. The spring 212 also serves to smooth the actuation of the electromagnetic brake 206. By varying the spring constant (natural frequency) during design, the designer of the actuator is able to tune and refine the characteristics of the vibrotactile feedback produced by the brake 206. Although the embodiment shown comprises a spring 210, the spring 210 is not necessary to provide resistive or vibrotactile feedback.

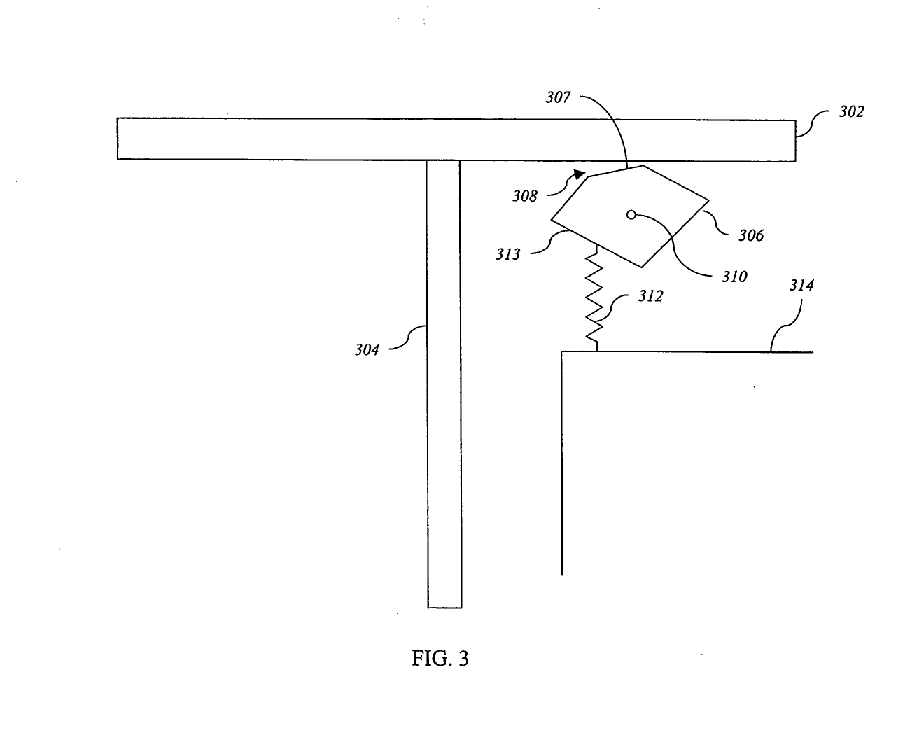

FIG. 3 is a side view of a manipulandum and haptic actuator in another embodiment of the present invention. The embodiment shown comprises a knob 302 mounted on a shaft 304. An electromagnetic brake 306 is mounted so that a gap 308 is formed between one side 307 of the electromagnetic brake 306 and the manipulandum 302.

In the embodiment shown, the electromagnetic brake 306 is a cube with an additional side 307 forming an angle between two adjacent sides, i.e., the cube has seven sides. The view shown in FIG. 3 is a cross section of the cube; i.e., only five of the sides of the cube are illustrated. When a current is applied to the electromagnetic brake 306, a surface of one side 307 of the electromagnetic brake 306 comes into contact with the knob 302, causing a resistance. The electromagnetic brake pivots about a mounting point 310, resulting in a varying gap 308 between the angled side 307 of the electromagnetic brake 306 and the manipulandum 302 when no current is applied to the electromagnetic brake. The angle allows part of the electromagnetic brake 306 to remain very close to the manipulandum 302, ensuring a smooth actuation of the resistive force while allowing the center of mass more movement, thereby increasing the energy of the vibrotactile effects.

The embodiment shown also comprises a spring 312. A first end of the spring 312 is attached to a side 313 of the electromagnetic brake 306 adjacent to a corner opposite the braking surface 307. The other end of the spring 312 is attached to a ground 314. Although the embodiment shown comprises a spring 312, the spring 312 is not necessary to provide resistive or vibrotactile feedback. When no current is applied to the electromagnetic brake 306, the spring 312 biases the angled side 313 flat up against the knob 302. When current is applied to the electromagnetic brake, the larger, flat surface of the electromagnetic brake 306 is attracted to the knob 302.

FIG. 4 is a cross-section view of a manipulandum and haptic actuator in another embodiment of the present invention. The embodiment shown comprises a knob 402 mounted on a shaft 404. An electromagnetic brake 406 is mounted so that a gap 408 is formed between a first side 407 of the electromagnetic brake 406 and the manipulandum 402. The electromagnetic brake 406 in the embodiment shown is an E-core. The E-core has a first side comprising projections. In the embodiment shown, the projections are closest to the manipulandum 402. A second side of the electromagnetic brake 406 opposite the projections comprises an indentation 411.

A mass 412 is connected to the electromagnetic brake 406. The shape of one side of the mass 412 corresponds to the indentation formed in the electromagnetic core 406 so that a portion of the mass 412 is situated within the indentation. In the embodiment shown, the mass 412 is connected to the electromagnetic core by a spring 412. Other types of connectors may be used. When the electromagnetic core 406 is energized, the mass 412 is drawn towards the core 406.

One end of a spring 414 is attached to the mass 412. The other end of the spring 414 is attached to a ground 416. Two additional springs 418a,b are present in the embodiment shown. One end of each of the springs 418a,b is attached to the electromagnetic brake 406. The other end of each of the springs 418a,b is attached to the ground 416. The spring constant of springs 418a,b are relatively large to provide bias of the electromagnetic brake 406 against the knob 402. The spring constant of spring 412 and spring 414 are relatively small.

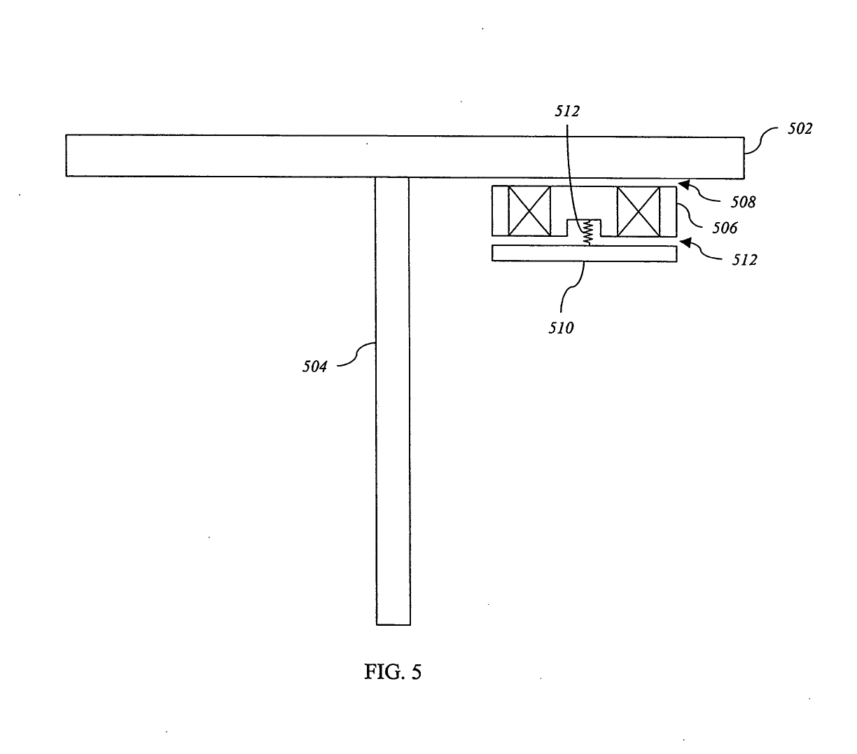

FIG. 5 is a cross-section view of a manipulandum and haptic actuator in another embodiment of the present invention. The embodiment shown comprises a knob 502 mounted on a shaft 504. An electromagnetic brake 506 is mounted so that a gap 508 is formed between a first side of the electromagnetic brake 506 and the manipulandum 502.

A second side 510 of the electromagnetic brake 506 opposite the knob 502 separated from the rest of the electromagnetic brake and attached by a spring 512. When the electromagnetic brake 506 is energized, electromagnetic brake 506 is drawn towards the knob 502 and the separated side 510 moves towards the electromagnetic brake 506 to complete the magnetic circuit. In vibrotactile mode, the separated side 510 is repeatedly and quickly drawn toward the bottom of the electromagnetic brake, creating vibrotactile effects. In the embodiment shown, the gap 512 between the separated side 510 and the electromagnetic brake 506 is greater than the gap 508 between the electromagnetic brake 506 and knob 502. The spring constant and the gap 512 can both be tuned to provide a useful resonance.

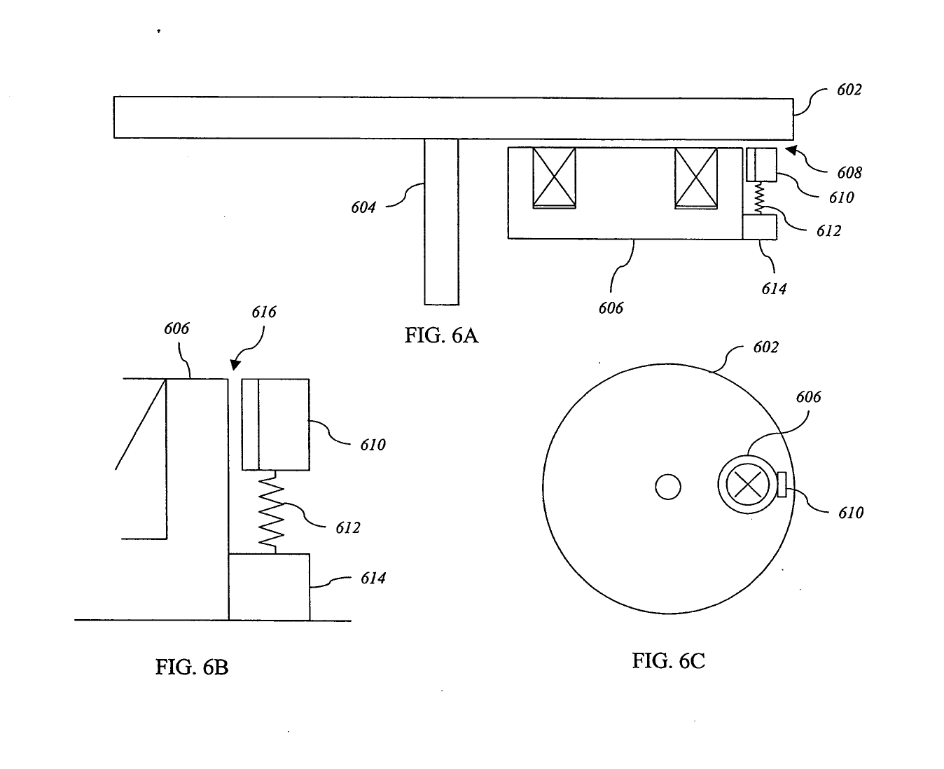

FIG. 6A is a cross-section view of a manipulandum and haptic actuator in another embodiment of the present invention. The embodiment shown comprises a knob 602 mounted on a shaft 604. An electromagnetic brake 606 is mounted so that a gap 608 is formed between a first side of the electromagnetic brake 606 and the manipulandum 602.

On one side of the electromagnetic brake 606, perpendicular to the first side, is a slug 610. The slug 610 is a small piece of metal influenced by the magnetic field produced by the electromagnetic core 606. The slug 610 is configured to directly contact the manipulandum 602 and provide vibrotactile feedback when current is applied to the electromagnetic brake 606. The slug 610 is attached to the electromagnetic brake 606 such that the slug 610 can move up and down in relation to the electromagnetic brake 606, for example, in a sleeve attached to the electromagnetic brake 606. The slug 610 is attached to a spring 612. The spring 612 is attached a ground 614, which is attached to the electromagnetic brake.

FIG. 6B is a magnified cross section view of the embodiment shown in FIG. 6. In the embodiment shown, the slug 610 is separated from the electromagnetic brake 606 by a gap 616. The slug 610 may be surrounded by, for example, brass to keep the slug 610 from being attracted to the side of the electromagnetic brake 606 and becoming fixed in place.

FIG. 6C is a perspective view of the embodiment shown in FIGS. 6A and 6B. The manipulandum is a knob 602 that is circular. The electromagnetic brake 606 is also circular and is mounted on one side of the manipulandum 602. The slug 610 is mounted on the side of the electromagnetic brake 606 and configured to contact the knob 602.

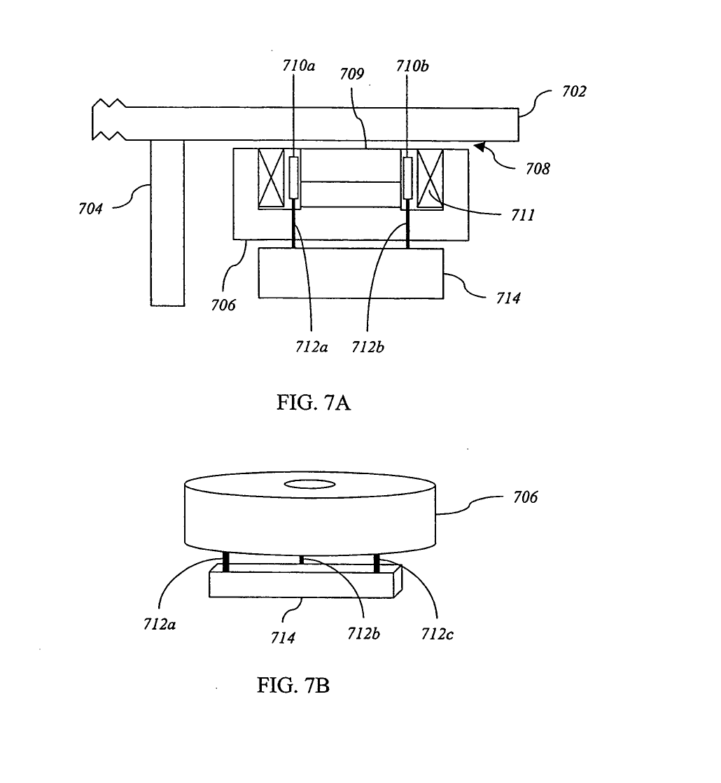

FIG. 7A is a cross-section view of a manipulandum and haptic actuator in another embodiment of the present invention. The embodiment shown comprises a knob 702 mounted on a shaft 704. An electromagnetic brake 706 is mounted so that a gap 708 is formed between a first side of the electromagnetic brake 706 and the manipulandum 702.

The electromagnetic brake 706 in the embodiment shown is a pot core. The pot core has a central core 709 around which a coil 711 is situated with an intentionally large gap. Mounted proximate to the central core 709 are two voice coils 710a,b. The plunger (not shown) of each of the voice coils 710a,b are attached to a shaft 712a,b. The shafts 712a,b are further attached to a mass 714. When the coil of the pot core is energized the voice coils 710a,b extend. When the polarity is reversed, the voice coils 710a,b retract. In one embodiment, the coil of the electromagnetic brake 706 and of the voice coils 710a,b is energized separately. In such an embodiment, the flux flows through the same steel. In one embodiment, a spring is present between the mass 714 and the electromagnetic brake 706 and is used in a manner similar to the manner in which springs are used in the other embodiments described herein.

FIG. 7B is a perspective view of the actuator shown in FIG. 7A. The electromagnetic brake 706 is circular. The shafts 712a,b,c extend from the bottom of the brake 706 and are attached to the top of the mass 714.

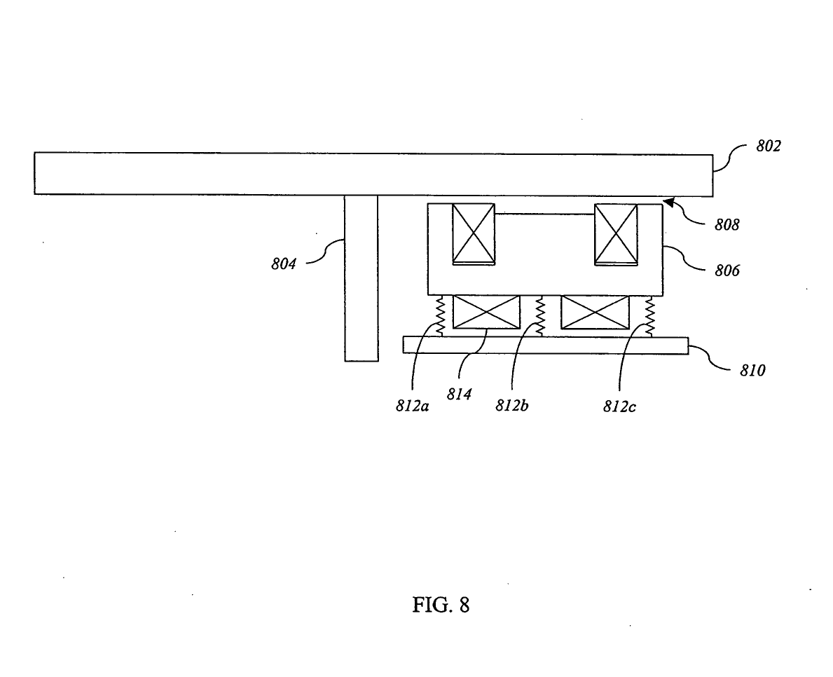

FIG. 8 is a cross-section view of a manipulandum and haptic actuator in yet another embodiment of the present invention. The embodiment shown comprises a knob 802 mounted on a shaft 804. An electromagnetic brake 806 is mounted so that a gap 808 is formed between a first side of the electromagnetic brake 806 and the manipulandum 802.

The electromagnetic brake 806 in the embodiment shown is an E-core. The E-core has a first side comprising projections. In the embodiment shown, the projections are closest to the manipulandum 802.

The electromagnetic brake 806 is attached to a mass 810 by three springs 812a,b,c. Also attached to the electromagnetic brake 806, between the electromagnetic brake 806 and the mass 810 is a magnetic coil 814. The magnetic coil 814 shown is separate from the coil utilized by the electromagnetic brake 806 to provide resistive force. The magnetic coil 814 serves to move the mass 810 towards and away from the electromagnetic brake 806, causing vibrotactile feedback.

In another embodiment of the present invention, a permanent magnet is mounted on the bottom of the secondary coil by a spring. Actuation of the secondary coil causes the permanent magnet to be drawn towards the secondary coil. In yet another embodiment, the mass 810 or permanent magnet is grounded. The secondary coil 814 moves up and down, for example, on springs, causing vibrotactile feedback.

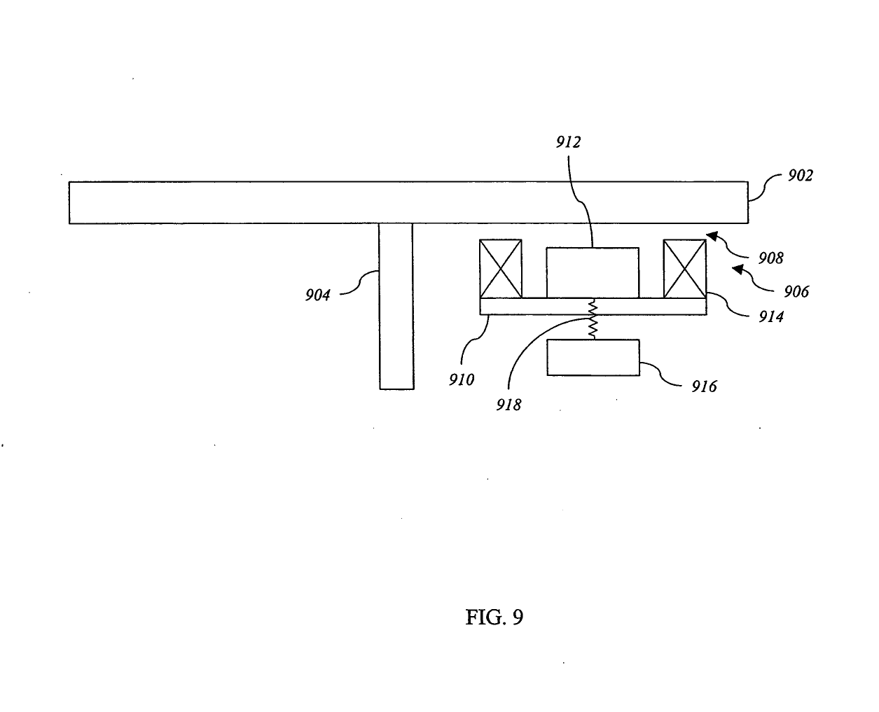

FIG. 9 is a cross-section view of a manipulandum and haptic actuator in yet another embodiment of the present invention. The embodiment shown comprises a knob 902 mounted on a shaft 904. An electromagnetic brake 906 is mounted so that a gap 908 is formed between a first side of the electromagnetic brake 906 and the manipulandum 902.

The electromagnetic brake 906 in the embodiment comprises a base 914. Mounted on the base is a block of magneto-strictive material 912. In the embodiment shown, the block of magneto-strictive material 912 is surrounded by a magnetic coil 914, which is also mounted on the base 910. When a magneto-strictive material becomes magnetized, it changes shape. The extent of the change is proportional to the intensity of the magnetic field but is not dependent on the polarity of the field. Materials having positive magneto-striction expand in the direction of the magnetic field; materials having negative magneto-striction expand in a direction opposite the magnetic field.

When the magnetic coil 914 is energized, the block of magneto-strictive material expands and provides a restive force on the manipulandum 902. Magneto-strictive materials can exert high forces and the change in shape has relatively low hysteresis. In the embodiment shown, the magneto-strictive material is Terfenol, which consists of Terbium (Te) and iron (Fe). Other magneto-strictive materials may also be used, such as nickel and cobalt.

Also attached to the magneto-strictive material 912 is a mass 916. The mass 916 is attached to the magneto-strictive material 912 by a spring 918. The spring 912 is attached to the magneto-strictive material 912 so that the mass 916 moves up and down as the magneto-strictive material expands and contracts, resulting in vibrotactile feedback.

In any of the embodiments shown in FIGS. 2-9, a bi-directional current may be applied to a coil to provide the vibrotactile feedback. In addition, in any of the embodiments, the materials used to construct the electromagnetic brake may be subject to magneto-strictive effects. If so, the magneto-strictive effect may contribute to the vibrotactile effect. For example, even standard steels change shape a small amount in the presence of magnetic fields. Also, in each of the embodiments shown in FIGS. 2-9, the electromagnetic brake is mounted in relation to the knob. It may be attached to a housing in which the knob is installed. The electromagnetic brake may instead be mounted to a grounded surface or in another suitable manner to maintain the desired relationship between the electromagnetic brake and the surface on which the brake is acting.

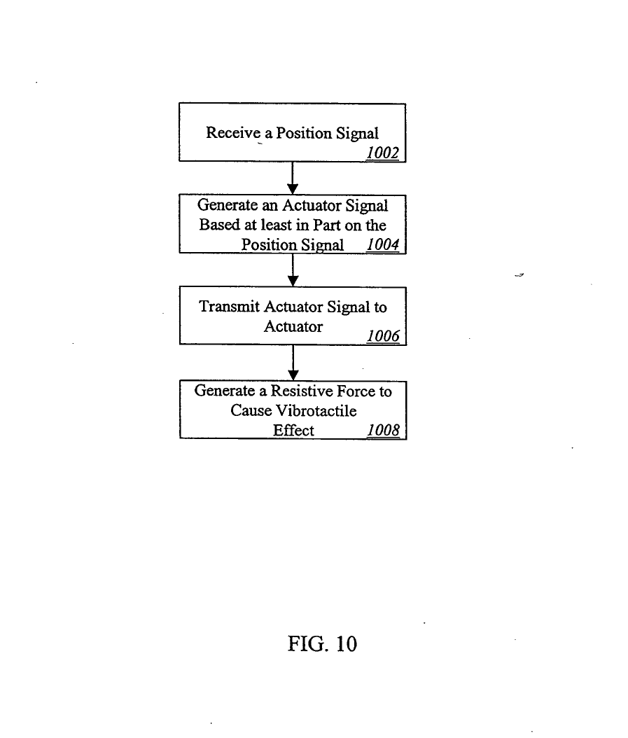

FIG. 10 is a flowchart illustrating a method of providing resistive and vibrotactile feedback in one embodiment of the present invention. In the embodiment shown, a user moves a manipulandum. A sensor is configured to sense the position of the manipulandum. For example, a coding wheel may be affixed to the shaft of a knob, and an optical encoder may be configured to sense movement of the coding wheel. When the knob is rotated, the shaft and the coding wheel rotate. The optical sensor senses the movement and is able to provide a position signal.

The sensor is in communication with a processor. The processor receives the position signal 1002. The processor includes program code on a computer-readable medium that includes instructions for generating an actuator signal based, at least in part on the position signal. For example, the processor may access a table that specifies the type, magnitude, frequency, etc. of an actuator signal to output based on the position signal and the status of a current application program a user is interacting with. For example, the table may indicate that if a user is accessing a heating ventilation and air conditioning (HVAC) application in an automobile and is currently adjusting the fan speed, a particular actuator signal is to be output at the position indicated by the position signal. The processor generates the signal 1004 and transmits the signal to an actuator 1006, such as the actuators shown in FIGS. 2 through 9.

The actuator receives the signal and, in response, generates a resistive force configured to cause a vibrotactile effect 1008. The vibrotactile effect may be output on the manipulandum or the housing. The actuator may be affixed to a spring. In such a case, the actuator signal may be configured to cause a resonance in the spring, thereby modifying the vibrotactile effect generated by the actuator.

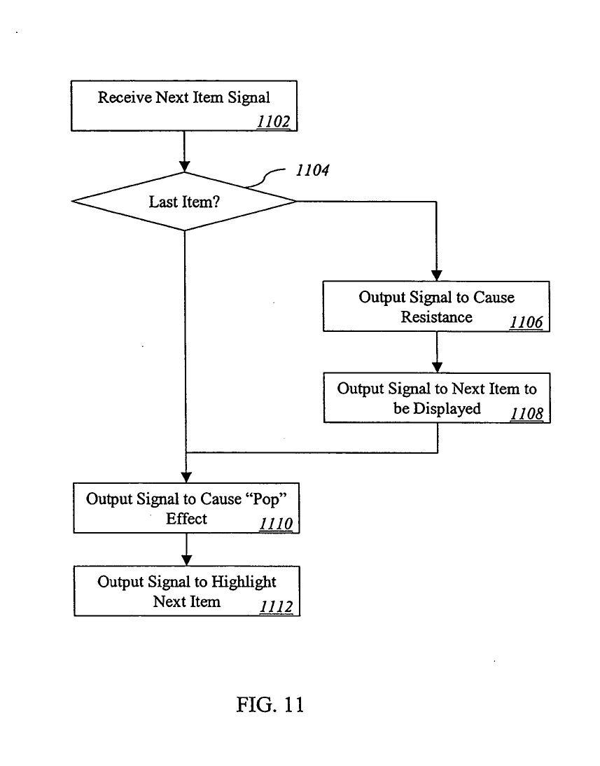

FIG. 11 is a flowchart illustrating a method for providing haptic feedback in one embodiment of the present invention. In the embodiment shown, a user accesses an address book application. When the user wants to view the next address book entry, the user rotates a knob through a limited range, e.g., 45 degrees. Address book entries are displayed and as the user moves the knob, an entry is highlighted corresponding to the movement of the knob within the limited range. Between each entry, the user experiences a “pop” effect. When the user reaches the last displayed entry at, for example, zero and forty-five degrees, a resistive actuator stops the knob from moving. However, undisplayed entries both before the first or after the last displayed entry are brought into the display and highlighted in turn. As the highlighting progresses from one entry to the next a vibrotactile actuator causes a pop to be felt by the user. In an embodiment of the present invention, the resistance and vibrotactile actuator is a single actuator.

In the embodiment shown in FIG. 10, a processor receives a next item signal 1002. The signal comprises information regarding whether or not the current item is the last displayed item. The processor interprets the information 1004. If the item is the last item, the processor outputs a signal to cause the actuator to output a resistance 1006. The signal also outputs a signal to cause the next item to be displayed. Whether or not the signal is the last item, the processor outputs a signal to cause the actuator to output a “pop” effect 1010 and a signal to cause the next item to be highlighted 1012.

The processor is in communication with the actuator and with a sensor that reads the position of the manipulandum and provides the position data to the processor. The processor may comprise, for example, a digital logic processor capable of processing input, executing algorithms, and generating output as necessary in response to the inputs received from the knob or from other input devices. Such processors may comprise a microprocessor, an ASIC, and state machines. Such processors comprise, or may be in communication with, media, for example computer-readable media, which stores instructions that, when executed by the processor, cause the processor to perform the steps described herein. Embodiments of computer-readable media comprise, but are not limited to, an electronic, optical, magnetic, or other storage or transmission device capable of providing a processor, such as the processor in communication with a touch-sensitive input device, with computer-readable instructions. Other examples of suitable media comprise, but are not limited to, a floppy disk, CD-ROM, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, comprising a router, private or public network, or other transmission device or channel, both wired and wireless. The instructions may comprise code from any computer-programming language, comprising, for example, C, C++, C#, Visual Basic, Java, and JavaScript. The processor may contain code for carrying out the methods described herein.

Embodiments of the present invention provide numerous advantages over conventional interface elements. For example, in a conventional device providing both resistive and vibrotactile feedback, at least two actuators are necessary, one for each effect. An embodiment of the present invention utilizes a single actuator to provide both effects. Accordingly, embodiments of the present invention are less expensive and require fewer discreet components. An embodiment of the present invention also provides increased functionality of the vibrotactile effect set being added to that of a resistive device, even when the target is not moving rotationally.

Embodiments of the present invention may be implemented in various environments and devices. For example, many cell phones and personal digital assistants employ scroll wheels to navigate within user interfaces. An embodiment may also be utilized by a remote control or on a DVD player control, such as a jog/shuttle.

The foregoing description of embodiments of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the present invention.

1. A device comprising:
a manipulandum; and
a resistive haptic actuator coupled to the manipulandum, the resistive haptic actuator configured to generate a resistive haptic force in order to provide a vibrotactile effect.

2. The device of claim 1, further comprising a processor in communication with the resistive haptic actuator, the processor configured to provide a signal to the resistive haptic actuator, the signal configured to cause the resistive haptic actuator to generate the resistive force in order to provide the vibrotactile effect.

3. The device of claim 1, further comprising a sensor in communication with the processor and operable to sense a motion of the manipulandum.

4. The device of claim 1, wherein the resistive actuator is configured to provide the vibrotactile effect on the manipulandum.

5. The device of claim 1, further comprising a housing for the manipulandum and wherein the resistive actuator is configured to provide the vibrotactile effect on the housing.

6. The device of claim 1, wherein the vibrotactile effect comprises one of a jolt, a shake, a buzz, and a pop.

7. The device of claim 1, wherein the resistive haptic actuator comprises an electromagnetic brake.

8. The device of claim 1, wherein the manipulandum comprises one of a knob, a slider, and a scroll wheel.

9. The device of claim 1, further comprising a spring having a first end and a second end, wherein the first end is attached to the resistive haptic actuator.

10. The device of claim 9, further comprising a mass attached to second end of the spring.

11. The device of claim 9, wherein the second end of the spring is attached to a ground.

12. The device of claim 9, wherein the spring comprises a first spring and further comprising a second spring having a first end and a second end, wherein the first end of the second spring is attached to the resistive haptic actuator.

13. The device of claim 1, further comprising a mass attached to the resistive haptic actuator.

14. The device of claim 13, wherein the resistive haptic actuator comprises an indentation and the mass comprises a corresponding projection.

15. The device of claim 1, wherein the resistive haptic actuator comprises an electromagnetic core.

16. The device of claim 15, wherein the electromagnetic core comprises one of a pot core, an E core, and a Terfinol core.

17. The device of claim 15, wherein the electromagnetic core comprises four sides and is configured to contact the manipulandum on a first side of the electromagnetic core.

18. The device of claim 17, wherein the first side of the electromagnetic core comprises a plurality of projections.

19. The device of claim 17, wherein the first side of the electromagnetic core comprises the top of a pot core.

20. The device of claim 17, further comprising a spring having a first end and a second end, wherein the first end of the spring is attached to a second side of the electromagnetic core opposite the first side of the electromagnetic core.
